(19) United States
(12) Patent Application Publication
(10) Pub. No.: US 2011/0076361 A1
(43) Pub. Date: Mar. 31, 2011

(54) BEVERAGE CARTRIDGE AND METHOD FOR BEVERAGE FORMATION USING FILTER AID

(75) Inventors: Peter Peterson, Waterbury, VT (US); Thomas J. Novak, Morristown, VT (US)

(73) Assignee: Green Mountain Coffee Roasters, Waterbury, VT (US)

(21) Appl. No.: 12/860,070

(22) Filed: Aug. 20, 2010

Related U.S. Application Data
(60) Provisional application No. 61/275,398, filed on Aug. 28, 2009.

(51) Int. Cl. B65B 29/06; A23F 5/26; A23L 2/38

(52) U.S. Cl. 426/79; 426/431; 426/77; 426/84

(57) ABSTRACT

A method and apparatus for forming a beverage involves the use of a filter aid, e.g., that is provided in a beverage cartridge with a beverage medium in a dry state. In one embodiment, a cartridge including a dried fruit material may also include a filter aid, such as perlite, diatomaceous earth or cellulose, that is mixed together with the fruit material. The filter aid may assist in flow through the beverage medium or through a filter, e.g., by helping prevent the clogging of pores of a filter used to remove particulate from a beverage formed by interaction of the beverage medium with water introduced into the cartridge. Thus, the filter aid may permit the use of some beverage media that would otherwise clog a filter and/or prevent proper dissolution of materials in the beverage media without the filter aid.

This application claims the benefit of U.S. Provisional application No. 61/275,398, filed Aug. 28, 2009.

### BACKGROUND

1. Field of Invention This invention relates to forming a beverage and a beverage cartridge involving the use of a filter aid.

2. Related Art

Cartridges for use with beverage forming machines are well known, and may include one or more filters as well as a beverage medium, such as ground coffee beans, tea leaves, etc. In some cartridges, a filter is located between two or more portions of an interior space of the cartridge, e.g., one portion in which a beverage medium is located, and a second portion into which liquid that has passed through the filter flows. An example of one such cartridge is disclosed in U.S. Pat. No. 5,840,189 and/or U.S. Pat. No. 6,607,762, which may be used with a beverage making machine like that described in U.S. Pat. No. 7,398,726, which patents are hereby incorporated by reference in their entirety. In use, the beverage forming machine introduces a fluid into the cartridge to interact with the beverage medium. In some machines, a piercing inlet needle pierces a surface of the cartridge (e.g., a portion of the cartridge container or lid) to introduce water into the cartridge, and an outlet needle of the machine is used to pierce the cartridge (e.g., a bottom wall of the cartridge container or a lid) permitting the liquid that has interacted with the beverage medium to flow through the filter and exit the cartridge.

### SUMMARY OF INVENTION

The formation of beverages using some types of beverage media, such as dry, powdered fruit materials, can be difficult in some circumstances. For example, when using a beverage cartridge that contains a powdered fruit material to form a beverage, the inventors have found that difficulties can arise, such as incomplete dissolution or other extraction from the fruit material and/or clogging of a filter in the cartridge that is used to remove insoluble particles from the beverage. That is, for example, some dried fruit materials tend to clump and/or swell when exposed to water, preventing proper wetting of the beverage medium as well as clogging of filter pores. The result can be that the resulting beverage will not include a suitable amount of ingredients extracted from the beverage medium, or the cartridge will fail because of a clogged filter. A clogged filter can cause an overpressure situation in the cartridge, which exposes the filter and/or the beverage machine to unacceptably high pressures. Relatively high pressures may cause the filter to burst, releasing beverage media into regions downstream of the filter, or cause the beverage machine to shut down because of the high pressure created.

Aspects of the invention relate to the use of a filter aid in a beverage cartridge which can help in the formation of a beverage, whether by improving flow of liquid through a beverage medium and/or by helping to resist filter clogging. The filter aid may include particles of cellulose, diatomaceous earth, perlite or other materials that help to improve flow through a beverage medium. The improved flow may help enhance extraction from the beverage medium (e.g., enhance a total amount of materials that are dissolved into a liquid flowing through the beverage medium) and/or help maintain suitable flow through a filter used to remove particles from a beverage stream. In one embodiment, the filter aid may be associated with the beverage medium, e.g.,. mixed with the beverage medium, in a dry form. This is in contrast to the way in which filter aid are often used, i.e., the filter aid and filtrand are often associated together with a liquid. Also, the inventors have found that certain filter aid-to-beverage medium weight ratios perform particularly well with dried fruit materials, e.g., weight ratios from about 10-50%. However, aspects of the invention are not limited to use with fruit materials or any particular weight ratio, e.g., a filter aid may be used with roast and ground coffee, tea leaves, herbs and/or spices, hot chocolate mix, dried vegetable matter, dried broth materials or any other suitable beverage medium in any suitable way.

In one aspect of the invention, a cartridge for use in forming a beverage includes a container defining an interior space having first and second portions. The container may have a surface, e.g., a bottom of a container or a lid, arranged to be pierced by a piercing element to permit a beverage to exit the interior space and/or to permit a liquid to enter the interior space. A beverage medium (such as ground coffee, tea, powdered fruit material, or other) may be located in the first portion of the interior space of the container and interact with liquid introduced into the container to form a beverage. A filter may be included in the container, e.g., attached at the sidewall of a frustoconical container, and be arranged so that liquid that interacts with the beverage medium in the first portion of the interior space flows through the filter toward the second portion of the interior space. A filter aid may be provided in contact with the beverage medium to assist in filtering of a beverage formed by interaction of the liquid with the beverage medium. For example, the filter aid can help reduce clogging of pores of a filter used to remove material from the beverage formed after mixing of liquid with the beverage medium and/or help enhance flow of liquid through the beverage medium (e.g., to help improve dissolution of materials in the beverage medium into the liquid). In one embodiment, the filter aid may be mixed in dry form with a dry beverage medium, enabling the cartridge to be stored for several days, weeks or months before use. Thereafter, liquid may be introduced to the beverage medium in the cartridge to form a beverage. The combination of a dry filter aid with a dry beverage medium has been surprisingly found to provide effective assistance in filtering a beverage. That is, conventional use of filter aids involves the mixture of filter aid with a liquid prior to, or simultaneous with, mixing of the filter aid with a material to be filtered. However, by combining a filter aid and beverage medium in dry form, the filter aid and beverage medium can be stored for extended periods in a beverage cartridge with a reduced concern for bacterial growth or other spoilage.

In another aspect of the invention, a beverage system includes a beverage machine having a receptacle arranged to receive a cartridge, a fluid inlet arranged to introduce liquid into the cartridge, and a fluid outlet to permit exit of a beverage from the cartridge. The system may also include a cartridge arranged to be received by the receptacle of the beverage machine. The cartridge may include a container defining an interior space and having an outer surface, a beverage medium in the interior space arranged to interact with liquid introduced by the fluid inlet into the container to form a beverage, a filter arranged to filter liquid that interacts with the beverage medium in the interior space, and a filter aid arranged to assist in filtering of beverage formed by the liquid and the beverage medium.

In another aspect of the invention, a method of making a beverage includes associating a cartridge with a beverage forming machine that uses the cartridge to form a beverage, introducing a liquid into the cartridge that mixes with the beverage medium, forming a beverage from the liquid and beverage medium, filtering the beverage with a filter, and assisting filtering of the beverage by use of a filter aid. The filter aid may resist the movement of materials in the beverage medium and liquid mixture that would otherwise clog pores of the filter and/or may help improve flow through the beverage medium.

In another aspect of the invention a method for forming a beverage includes providing a cartridge having an internal space, and providing a dry beverage medium in the internal space of the cartridge. The beverage medium can include at least one ingredient that forms a beverage when interacted with a liquid that is introduced into the internal chamber. A filter aid may be provided with the beverage medium in the internal space so as to reduce clogging of pores of a filter used to remove material from the beverage formed after interaction of liquid with the beverage medium. In one embodiment, the beverage medium is arranged for forming a beverage having a volume of about 32 ounces or less, and the beverage medium can include fruit or vegetable material or other plant material, such as dried fruit material, roast and ground coffee, or leaf tea. The filter aid can include at least one of perlite, diatomaceous earth, diatomite, and cellulose.

In another aspect of the invention, a beverage cartridge includes a container having an internal space, a filter located in the internal space, a dry beverage medium in the internal space, and a dry filter aid associated with the beverage medium in the internal space. The filter can be arranged in the internal space to separate two portions of the internal space such that the beverage medium and filter aid are located in a first portion that is separated by the filter from a second portion. In one embodiment, the filter aid is mixed with the beverage medium, e.g., such that a ratio of a filter aid weight to a beverage medium weight is about 0.1 to about 0.5 or greater.

In another embodiment, a beverage cartridge includes a container having an internal space, a beverage medium in the internal space that has at least one ingredient that forms a beverage when mixed with a liquid, and a compound filter. The compound filter can include a filter paper with a first portion of bound cellulose fibers arranged to separate first and second portions of the internal space, and a second portion of loose cellulose fibers contained in the first portion of the internal space. The loose cellulose fibers may act as a filter aid, e.g., to help assist flow through beverage medium that is in the first portion of the internal space and/or through the filter paper. The loose cellulose fibers may be mixed with the beverage medium in the first portion of the internal space or otherwise be in contact with the beverage medium, e.g., the loose fibers may be arranged between the beverage medium and the filter paper. In one embodiment, the loose cellulose fibers may each have a length that is about 60-145 microns, which has been found to be effective in some cartridge arrangements. The amount of loose cellulose fibers may be varied as suitable, e.g., the loose cellulose fibers may have a total weight that is about 2-50% of a weight of the beverage medium.

These and other aspects of the invention will be apparent from the following description and claims.

### BRIEF DESCRIPTION OF DRAWINGS

Aspects of the invention are described below with reference to the following drawings in which like numerals reference like elements, and wherein:

FIG. 1 is a cross sectional view of a beverage cartridge in an illustrative embodiment;

FIG. 2 is an exploded view of the cartridge of FIG. 1;

FIG. 3 is a cross sectional view of the FIG. 1 cartridge in use for forming a beverage in an illustrative embodiment;

FIG. 4 is a perspective view of a beverage machine usable in accordance with aspects of the invention;

FIG. 5 is a side view of the beverage machine of FIG. 4;

FIG. 6 is a schematic block diagram of components of a beverage machine usable in accordance with aspects of the invention;

FIG. 7 shows steps in a method of manufacturing a cartridge in accordance with aspects of the invention;

FIG. 8 shows steps in a method of preparing a beverage in accordance with aspects of the invention;

FIG. 9 shows a graph of beverage absorbance versus amount of filter aid in an illustrative example involving the use of a dried strawberry powder beverage medium;

FIG. 10 shows a graph of beverage absorbance versus amount of filter aid in an illustrative example involving the use of a dried cherry powder beverage medium; and

FIG. 11 shows a graph of beverage absorbance versus amount of filter aid in an illustrative example involving the use of a dried pineapple powder beverage medium.

### DETAILED DESCRIPTION

It should be understood that aspects of the invention are described herein with reference to the figures, which show illustrative embodiments. The illustrative embodiments described herein are not necessarily intended to show all aspects of the invention, but rather are used to describe a few illustrative embodiments. Thus, aspects of the invention are not intended to be construed narrowly in view of the illustrative embodiments. In addition, it should be understood that aspects of the invention may be used alone or in any suitable combination with other aspects of the invention.

As discussed above, aspects of the invention involve the use of a filter aid in a beverage cartridge that contains a beverage medium for forming a beverage, such as coffee, tea, soup, another type of drink made from a powdered concentrate or other material, beverage granules, and so on. The beverage medium may include any suitable material, such as roast and ground coffee, leaf tea, cocoa, dried fruit materials, dried plant materials, instant coffee or tea, powdered drink mixes, bouillon, juice extract, dried fruit or vegetable purees, whole macerated dried fruits, dried vegetable or plant peels and/or pomace, dried concentrates, dried clarified juices, pectins, sweeteners, creamers, dried dairy materials, food acids, gums, clouding agents, bulking agents, thickeners, flavorings, dyes, and so on. All or portions of the beverage medium may be particulated, sized and/or agglomerated as described for example in U.S. Patent Publication 2010/0028495, published Feb. 4, 2010 (which is hereby incorporated by reference in its entirety), or otherwise arranged in any suitable way.

The beverage formed using the beverage medium may be filtered, e.g., to reduce an amount of insoluble particulate matter in the beverage, by one or more filter elements associated with the cartridge. For example, the cartridge may have a piece of filter paper secured within the cartridge and arranged so that beverage passes through the filter paper before exiting the cartridge. In another arrangement, a portion of the cartridge outer surface may operate as a filter, e.g., as in the case of a pod-type cartridge where an outer filter paper covering filters the beverage or where a foil or other impermeable outer covering of the cartridge is pierced by contact with a grid-like or other structure that forms openings in the covering that are suitably sized to act as a filter. In another arrangement, the cartridge may have relatively small openings formed in otherwise impermeable material, e.g., small holes in a solid plastic sheet, that function as a filter. In short, the filter may be arranged in any suitable way.

In accordance with one aspect of the invention, the inventors have found that adding a filter aid, such as perlite, diatomaceous earth, diatomite, and/or cellulose, to a beverage medium can permit the use of beverage media or materials that otherwise would be unusable for use in forming a beverage in a beverage cartridge. For example, some beverage media, such as dried fruit juice, or dried fruit purees, cannot be used in at least some beverage cartridges that employ a filter paper-type filter because material in the powdered material clogs filter pores of the filter paper, preventing flow through the filter. By “powdered” it is meant to include dried materials that have undergone some form of size reduction, such as grinding, pulverizing, slicing, cutting or milling. In some situations, the beverage material, upon wetting, can swell and become difficult to percolate. In some other situations, the beverage material, upon wetting, can become semi-gelatinous and/or sticky, and form an impervious layer, thereby preventing flow of brewing liquid to permeate the layer and pass through the filter. Clogging of the filter causes relatively high backpressure to be generated in the cartridge as additional water or other liquid is introduced into the cartridge. At high enough backpressure levels, many beverage machines (such as coffee or tea brewers) will shut down, stopping beverage production. However, with the use of a filter aid with the beverage medium, clogging of the filter can be reduced enough to permit the formation of a beverage without creating an unacceptably high backpressure in the cartridge. The filter aid may not only help reduce clogging of the filter, but may help increase the porosity of the beverage medium or otherwise facilitate flow of liquid through the beverage medium during brewing. Enhancing flow through the beverage medium may help materials in the beverage medium to dissolve more quickly or otherwise be more effectively extracted by the liquid.

In another aspect of the invention, the filter aid is combined with the beverage medium while both the filter aid and beverage medium are in a dry state. (By “dry” it is meant that the beverage medium and filter aid have a total moisture content of 10% or less by weight.) Thereafter, liquid such as water may be added to the beverage medium/filter aid combination to form a beverage. Combining of filter aid and beverage medium in a dry state may help the filter aid function more effectively, e.g., when the beverage medium includes a material that swells or otherwise increases volume when exposed to moisture. By combining the filter aid with beverage medium before exposure to significant moisture, the filter aid can help prevent the migration and subsequent swelling of materials in filter pores that would cause a filter to fail. In addition, having the filter aid and beverage medium in a dry state may reduce the need to pasteurize or otherwise treat the beverage medium/filter aid before extended storage in a beverage cartridge in the case of a concern that the beverage medium may spoil, e.g., by the growth of bacteria, mold or other moisture-loving organisms. Alternately, the dry state of the beverage medium and filter aid may permit the use of permeable beverage cartridges, such as filter pods, because there would be no liquid in the beverage medium/filter aid combination to leak from the cartridge.

In one aspect, the filter aid can be mixed with a beverage ingredient such as a fruit puree while the puree is still wet with its natural moisture. Thereafter, the mixture can be dried and made into particles suitable for inclusion in a beverage cartridge. (The fruit puree beverage medium and filter aid can also be mixed with other beverage materials, such as sweeteners, if desired.) Thus, although the filter aid and beverage medium may be initially combined in a wet state, the filter aid and beverage medium may be included in a beverage cartridge while in a dry state, providing at least some of the advantages mentioned above. In other embodiments, the filter aid may be mixed with the beverage medium in a dry state, e.g., before the filter aid/beverage medium mixture is placed in a cartridge. Alternately, the filter aid and beverage medium may be added separately into the cartridge, and mixed (if desired) while in the cartridge, such as by shaking, stirring, etc.

Conventional use of filter aids teach that a filter aid can be added as a filter precoat or as a body feed, i.e., can be mixed with a liquid-based slurry or other mixture. See page 476 of the book Fundamentals of Food Process Engineering, Third Edition, by Romeo T. Toledo, published in 2007 by Springer Science and Business Media LLC, ISBN-10-38729019-2. In both these methods of use, the filter aid is mixed into a liquid and then the liquid-filter aid slurry is pumped through the filter. In the instance of a filter precoat wherein a protective layer of filter aid is deposited onto a filter media (such as a filter fabric), the filter aid is mixed with clear water and the slurry is pumped through the filter media, leaving behind a permeable layer/filter aid cake. Then, the liquid material to be filtered (containing suspended solids) is pumped into the filter and the precoated filter aid protects the filter during the filtering operation. In such an instance, the precoated filter aid prevents the plugging of the filter pores with the suspended solids. Those solids instead collect in the precoat cake layer and not in the filter media pores. (Note that aspects of the present innovations include the use of a filter that is pre-coated with filter aid, e.g., the filter aid is initially in wet form on the filter and later dried, and included in a cartridge with dry beverage media.) In the instance of a body feed utilization of a filter aid, the filter aid is mixed with the liquid material (containing the suspended solids) to be filtered. Then, the resulting slurry is pumped through a filter media (either naked or with an applied filter aid precoat). In this body feed approach, the suspended insoluble solids that are to be filtered-out of the liquid deposit onto the filter media along with the incorporated filter aid and form a filter cake. The filter aid helps keep that cake porous and reduces the pressure drop experienced during the filter operation.

The present innovations, in at least some aspects, operate in the mode that the filter aid is not mixed with the water or other liquid being introduced into the cartridge. The filter aid is instead mixed into, or is part of, or is in contact with, the dry beverage materials prior to introduction of the liquid. As brewing water or other liquid is provided into the cartridge containing the filter aid and beverage materials, the liquid dissolves the soluble materials in the beverage materials and also begins to wet the insoluble materials along with the filter aid. During the wetting, the insoluble materials can swell. Also, as the soluble materials dissolve, the volumetric concentration of the insoluble materials increases (since the soluble materials dissolve into the brewing liquid and pass out of the cartridge). The in-situ presence of the filter aid in the initial dry mixture (followed by a dynamically-densifying mixture during brewing) automatically provides the necessary porosity to allow for efficient flow of the liquid through the beverage material. This mode of operation is surprisingly effective and not taught by conventional art.

Various ratios of beverage medium materials and filter aids can be used. The ratio can be adjusted depending on the nature of the beverage media to be filtered. For example, beverage materials with high pectin contents may require higher levels of filter aids whereas beverage materials with no pectin may utilize lower ratios of filter aid to beverage material. An example is a beverage medium and filter aid mixture consisting of 23 grams of granulated white sugar and five grams of a dried mixture of concentrated grape puree combined with a suitable amount of cellulose filter aid, e.g., about 1 to 3 grams. An example of a preferred filter aid in some embodiments is CreaClear SC-150 cellulose filter aid manufactured by CreaFill Fibers Corporation, 10200 Worton Road, Chestertown, Md. 21620. Further examples and details regarding illustrative embodiments are discussed below.

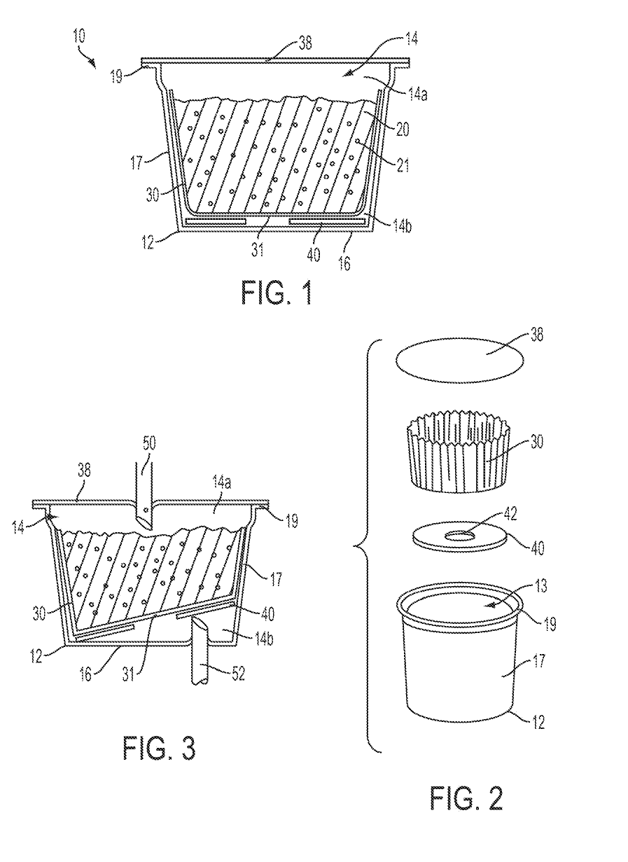

FIGS. 1 and 2 show a side cross-sectional view and an exploded perspective view, respectively, of an illustrative cartridge 10 that incorporates one or more aspects of the invention. The cartridge 10 may be used in a beverage machine to form any suitable beverage such as tea, coffee, other infusion-type beverages, beverages formed from a liquid or powdered concentrate, etc. Thus, the cartridge 10 may contain any suitable beverage medium 20, e.g., ground coffee, tea leaves, dry herbal tea, dry fruit materials including powders, powdered beverage concentrate or juices, and/or other beverage-making material (such as powdered milk, dairy ingredients, sugar, or other materials). The beverage medium 20 may be arranged (e.g., have a suitable weight and/or volume) for producing a beverage having a volume of about 2-32 fluid ounces. That is, the beverage medium 20 may have suitable material to produce a 2-32 fluid ounce volume beverage that has a commercially acceptable flavor. In one illustrative embodiment, the cartridge 10 contains a beverage medium 20 that is configured for use with a machine that forms coffee and/or tea beverages, however, aspects of the invention are not limited in this respect.

The cartridge 10 also includes a filter aid 21 (shown schematically as particles mixed with the beverage medium 20), which may include perlite, diatomaceous earth, diatomite, and/or cellulose. In one embodiment, the filter aid 21 and the beverage medium 20 may be in a dry state prior to the introduction of liquid into the cartridge to form a beverage. The filter aid 21 may have an overall weight that is less than the beverage medium, e.g., in a ratio of about 1:1 or less, although in some embodiments the weight of the filter aid 21 can be greater than the beverage medium. For example, the beverage medium 20 may include about 1 to 30 grams of powdered fruit materials and other beverage materials, together with 0.05 to 75 grams of filter aid. In some preferred embodiments, the filter aid to beverage medium weight ratio may be about 0.1 to 0.5, e.g., when the beverage medium includes a powdered fruit material.

In some arrangements, the inventors have found that a fibrous filter aid, such as a loose cellulose fibers, can be particularly effective. In some cases, the average length of the cellulose fibers has been found to be important to the functioning of the filter aid. For example, a relatively short average fiber length may result in too much of the filter aid passing through a filter (e.g., through a piece of filter paper including bound cellulose fibers) and ending up in the finished beverage. On the other hand, a relatively long average fiber length may make the filter aid difficult to handle, e.g., during manufacture of cartridges, since the long fiber length may cause the fibers to form tangled masses that are difficult to mix with beverage media or otherwise provide in a cartridge. In some embodiments, the inventors have found that an average fiber length of about 60 to 145 micrometers when using a cellulose fiber material (e.g., having a loose density of about 30-200 grams/liter and a moisture content of less than about 10%) provides an effective balance of filter aid performance and manufacturability. Of course, other average fiber lengths could be used as desired. Moreover, use of a filter aid in accordance with aspects of the innovations is not limited to the use of fibrous materials.

An exemplary mixture of a beverage medium mixture and a filter aid can be prepared as follows. Concentrated whole grape puree (while still wet) is mixed with dry CreaClear SC-150 to form a paste. (The SC-150 material is a fibrous cellulose material having an average fiber length of about 120 micrometers.) The paste is dried and milled into a powder. The ratio of dry filter aid to dry grape solids is about 0.3 to 1.25 by weight. Then, 0.04 grams of a suitable anti-caking agent is applied to the milled dried mixture. 4 grams of the resulting mixture is then mixed with 23 grams of granulated white sugar, 2 grams of dried blueberry puree, 1.0 gram of grape flavoring material, 0.35 grams of malic acid, 0.15 grams of citric acid and 0.015 grams of stevia (Reb A). This beverage medium-filter aid mixture can be brewed in a coffee brewer, such as in a filtered K-Cup brand cartridge using a Keurig brewer where the beverage is dispensed over ice to form a grape-flavored cold beverage.

Another exemplary arrangement for a beverage medium and a filter aid can be prepared as follows. 9.5 grams of granulated brown sugar are mixed with 10 grams of dried apple powder, 1 gram of CreaClear SC-150, 0.5 grams of malic acid and 0.5 grams of apple flavoring material. This beverage medium-filter aid mixture can be brewed in a K-Cup cartridge in a Keurig brewer to form a “hot apple cider” beverage.

In this illustrative embodiment shown in FIGS. 1 and 2, the cartridge 10 includes a container 12 that includes an interior space 14 having a first portion 14a and a second portion 14b. It should be understood, however, that other additional portions of the interior space and/or sub-portions of the first and second portions, may be provided in other embodiments. For example, it is possible for the cartridge to have two interior space portions that respectively hold different beverage media. That is, a first portion of beverage media (such as dried fruit material) may be included in the first portion 14a of the interior space 14, and a second portion of beverage media (e.g., a material that does not require filtering or use of a filter aid, such as a sweetener) may be included in the second portion 14b, downstream of the filter 30. Other arrangements will occur to those of skill in the art. In this embodiment, the container 12 may have a frustoconical cup shape with a sidewall 17 and an opening 13. However, in other embodiments, the container 12 may have a fluted, conical, or cylindrical shape, may be in the form of a square cup, a domed cup, a sphere or other suitable form, may have a fluted, corrugated, or otherwise shaped sidewall, and so on. Also, the container 12 need not necessarily have a defined shape, as is the case with some beverage sachets and pods. For example, although the container 12 in this embodiment has a relatively rigid and/or resilient construction so that the container 12 tends to maintain its shape, the container 12 could be made to have a more compliant and/or deformable arrangement, e.g., like a sachet container made from a sheet of deformable material. Thus, an interior space defined by the container 12 may be formed only after the container material is formed around a beverage medium, filter and/or other cartridge components, such as when two filter paper layers (container material) are joined together around a charge of coffee grounds to form a cartridge.

If the container 12 includes an opening 13, the opening 13 may be closed by a lid 38, e.g., a foil and polymer laminate material that is attached to a rim 19 of the container 12. Of course, the container 12 need not include a lid 38, e.g., where the container is arranged in a sachet-type or pod-type configuration. The container 12 (with or without the lid 38) may provide a barrier to moisture and/or gases, such as oxygen or water. For example, the container 12 may be made of a polymer laminate, e.g., formed from a sheet including a layer of polystyrene or polypropylene and a layer of EVOH and/or other barrier material. Such an arrangement may provide suitable protection for the beverage medium 20, e.g., from unwanted exposure from moisture, oxygen and/or other materials. In other embodiments, the interior space 14 may be enclosed by a permeable covering, such as a filter paper, a polymer sheet, a mesh layer, or other permeable material, or in some other manner, as the invention is not limited in this regard.

The cartridge 10 may also include a filter 30 in the container 12 and at least partially located in the interior space 14 (or otherwise arranged). (In some embodiments, the cartridge 10 need not include a filter, but instead a filter used to filter a beverage may be external to the cartridge, e.g., part of a beverage machine that uses the cartridge.) The filter 30 may be arranged between the first and second portions 14a and 14b of the interior space 14 so that liquid in the first portion 14a of the interior space that interacts with beverage medium 20 flows through the filter 30 and toward the second portion 14b of the interior space 14 before exiting the container 12. The filter 30 may be entirely located in the interior space 14 or portions of the filter 30 may extend outside the interior space 14, as aspects of the invention are limited in this respect. For example, portions of the filter 30 may be joined to the lid 38 and/or between the lid 38 and the rim 19, and thus be located outside of the interior space 14. In addition, the filter 30 may include one or more portions that function to filter liquid passing through the filter 30, as well as portions that are impermeable or otherwise restrict flow. The filter 30 may be the only element in the interior space 14 that separates the first and second portions 14a and 14b, or other components, such as walls, ribs, or other structures in addition to the filter 30 may physically separate two or more portions of the interior space 14 from each other. However, in a flow sense, the filter 30 may be the only component that separates or divides two or more portions of the interior space 14, e.g., liquid may need to flow through the filter 30 to pass from the first portion 14a to the second portion 14b. Of course, the filter 30 may have multiple stages, e.g., a coarse filter portion that filters out relatively large particles, followed by a fine filter portion that filters relatively smaller particles. Thus, the filter 30 may include two or more separate components, if desired.

In this illustrative embodiment, the filter 30 may have a substantially frustoconical shape with fluted sidewalls and a generally flat bottom 31, as shown. However, the filter 30 may have any suitable shape, such as a cylindrical shape, a square cup shape, a domed shape, a flat sheet, or other. The filter 30 may be the attached to the container 12 in any suitable way, such as by an adhesive, thermal welding, a mechanical interference fit, etc. In this illustrative embodiment, the filter 30 may include a combination of polypropylene and cellulose materials (i.e., the filter 30 may include a filter paper that includes bound cellulose fibers) and may be attached to the container sidewall 17 at an upper portion of the filter 30 by thermal welding, but the filter 30 may be attached to a rim 19 of the container 12, or in any other suitable location. In another embodiment, the filter 30 may be formed as part of the container 12, e.g., where the container 12 is perforated by an external structure that forms one or more openings that function as a filter. In another embodiment, the container 12 (including the lid 38) may include a permeable element that functions as a filter. Other embodiments will occur to those of skill in the art.

When using the cartridge in this illustrative embodiment to form a beverage, for example, as shown in FIG. 3, the lid 38 may be pierced by an inlet piercing element 50 (e.g., a needle) so that water or other liquid may be introduced into the cartridge 10. Other inlet piercing arrangements are possible, such as multiple needles, a shower head, a non-hollow needle, a cone, a pyramid, a knife, a blade, etc. A beverage machine may include multiple piercing elements of the same type or of different types, as the invention is not limited in this respect. In another arrangement, a beverage machine may include a piercing element that forms a hole in a container surface and thereafter a second piercing element may pass through the formed hole to introduce liquid into (or conduct liquid out of) the container.

The cartridge 10 may also be penetrated by an outlet piercing element 52 (e.g., a needle) at a bottom 16 of the container 12. In some embodiments, the piercing element 52 may always extend about the same distance into the cartridge 10, e.g., up to about 0.25 inches into the cartridge 10. However, piercing element extension into the cartridge may vary in length, width or other parameters as different sizes, types and configurations of piercing elements fall within the scope of the invention. In the case that the cartridge is pierced (either for an inlet or an outlet), the cartridge 10 may include a guard element 40 to help prevent damage to the filter 30 and/or entry of beverage medium 20 into the piercing element. In this embodiment, the cartridge 10 includes a guard element 40 in the form of a washer-shaped element with a central opening 42 to help prevent contact of the piercing element 52 with the filter 30 (see FIG. 3), but the guard element may take other arrangements. In this illustrative embodiment, the piercing element 52 remains in place so as to permit beverage to exit the opening formed in the container 12. However, in other embodiments, the piercing element 52 (if used at all) may withdraw after forming an opening, allowing beverage to exit the opening without the piercing element 52 being extended into the cartridge 10. In some embodiments, the lid 38 can also be pierced with an outlet piecing element where the filter element 30 and lid 38 are arranged such that the outlet piercing element can access the second portion 14b.

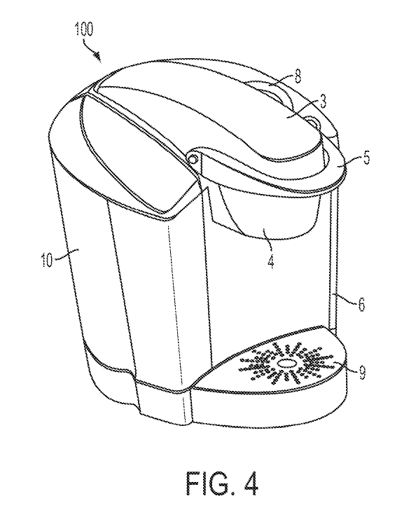

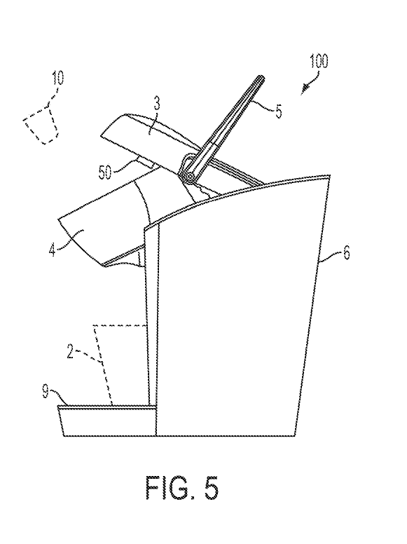

A cartridge arranged in accordance with one or more aspects of the invention may be used with any suitable beverage machine, such as any one of the brewers currently sold by Keurig, Incorporated of Reading, Mass. For example, FIGS. 4 and 5 show a perspective view and a side view, respectively, of a beverage forming apparatus 100 that may be used to form any suitable beverage, such as tea, coffee, other infusion-type beverages, beverages formed using a cartridge 10. In this illustrative embodiment, the apparatus 100 includes an outer frame or housing 6 with a user interface 8 that the user may operate to control various features of the apparatus 100. As is known in the art, a beverage cartridge 10 may be provided to the apparatus 100 and used to form a beverage that is deposited into a cup 2 or other suitable container that is placed on a drip tray 9 or other support, if any. The cartridge 10 may be manually or automatically placed in a cartridge receiving portion defined by first and second portions 3 and 4 of the beverage forming apparatus 100. For example, by lifting a handle 5, the user may move the first and second portions 3 and 4 to an open position to expose a cup-shaped or otherwise suitably shaped area in which the cartridge 10 may be placed. After placement of the cartridge 10, a handle 5 or other actuator may be moved in a manual or automatic fashion so as to move the first and second portions 3 and 4 to a closed position (shown in FIG. 4), thereby at least partially enclosing the cartridge 10 within a brew chamber. It should be understood, however, that the cartridge 10 may be received in any suitable way by the apparatus 100, as the way in which the apparatus 100 receives or otherwise uses the cartridge 10 is not critical to aspects of the invention.

Once the cartridge 10 is received, the beverage forming apparatus 100 may use the cartridge 10 to form a beverage. For example, one or more inlet needles 50 (see FIG. 5) associated with the first portion 3 may pierce the cartridge 10 so as to inject heated water or other liquid into the cartridge 10. The injected liquid may form the desired beverage or a beverage precursor (i.e., a substance used in a further operation to form a beverage, such as by the addition of milk, a flavoring, etc.). The second portion 4 may also include one or more outlet needles or other elements 52 (not shown in FIGS. 4 and 5) to puncture or pierce the cartridge 10 (as needed) at an outlet side to permit the formed beverage to exit the cartridge 10 (see FIG. 3, for example).

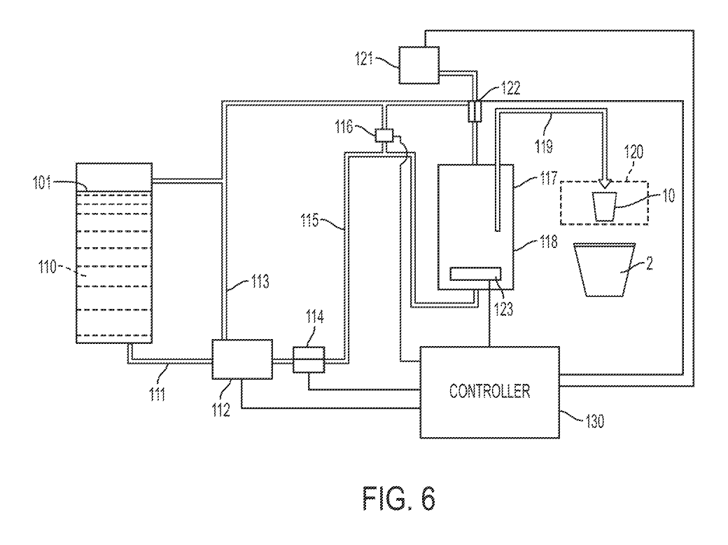

FIG. 6 shows a schematic block diagram of various components included in a beverage forming apparatus 100 in one illustrative embodiment. Those of skill in the art will appreciate that a beverage forming apparatus 100 may be configured in a variety of different ways, and thus aspects of the invention should not be narrowly interpreted as relating only to one type of beverage forming apparatus. Water or other liquid from a storage tank 110 may be provided via a supply conduit 111 to a pump 112 (such as a centrifugal pump), which pumps the liquid via a pump conduit 115 to a metering tank or chamber 118. Operation of the water pump 112 and other components of the apparatus 100 may be controlled by a controller 130, e.g., including a programmed processor and/or other data processing device along with suitable software or other operating instructions, one or more memories, temperature and liquid level sensors, pressure sensors, input/output interfaces, communication buses or other links, a display, switches, relays, triacs, or other components necessary to perform desired input/output or other functions. The metering tank 118 may be filled with a desired amount of liquid by any suitable technique, such as running the pump 112 for a predetermined time, sensing a water level in the metering tank 118 using a conductive probe sensor or capacitive sensor, detecting a pressure rise in metering tank 118 when the liquid fills the tank, or using any other viable technique. For example, the controller 130 may detect that the metering tank 118 is completely filled when a pressure sensor detects a rise in pressure indicating that the water has reached the top of the metering tank 118. Water in the tank may be heated, if desired, by way of a heating element 123 whose operation is controlled by the controller 130 using input from a temperature sensor or other suitable input. Water in the metering tank 118 may be dispensed via a metering tank conduit 119 to a brew chamber 120 or other beverage forming station that holds a cartridge 10. Liquid may be discharged from the metering tank 118 by pressurizing the metering tank with air provided by an air pump 121 that causes the liquid to be discharged out of a tube 117 and into the metering tank conduit 119. Completion of the dispensing from the metering tank 118 may be detected in any suitable way, such as by detecting a pressure drop in the metering tank 118, by detecting a water level change in the metering tank 118, or using any other viable techniques. Liquid may alternately be discharged from the metering tank 118 by the pump 112 operating to force additional liquid into the tank 118, thereby displacing water out of the tank 118 and to the brew chamber. A flow sensor or other suitable device may be used to determine the amount of liquid delivered to the tank 118, and thus the amount of liquid delivered to the brew chamber. Alternately, the pump 12 may be a piston-type or metering pump such that a known volume of liquid may be delivered from the pump 112 to the tank 118, thus causing the same known volume to be delivered to the brew chamber 120. Liquid may be introduced into the cartridge 10 at any suitable pressure, e.g., 1-2 psi or higher.

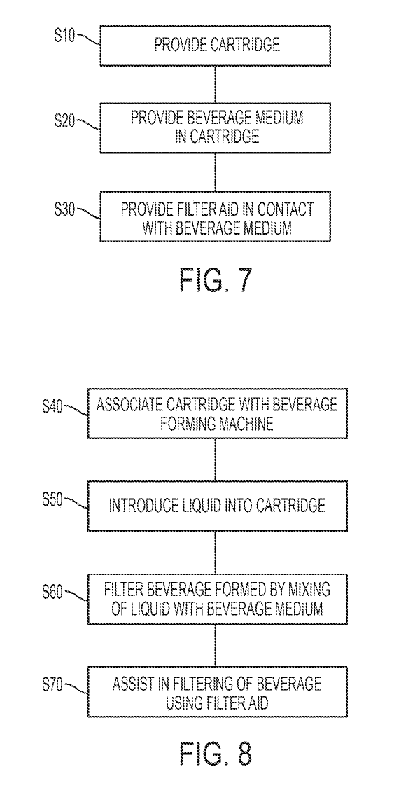

Another aspect of the invention includes a method of manufacturing a cartridge. Steps of one such illustrative method are shown in FIG. 7. In step S10, a cartridge is provided. As discussed above, the cartridge may be arranged in any suitable way, such as in the way of a conventional pod (e.g., two sheets of filter paper joined to form a space in which a beverage medium is located), a sachet (e.g., a pouch formed by an impermeable sheet that contains a beverage medium and filter such that introduction of water into the pouch causes the pouch to open and beverage to exit the pouch after passing through the filter), or other arrangement such as a cup-shaped container that holds a beverage medium and is closed by a lid. (By “cup” herein it is meant a vessel having a shape that forms an internal space that is accessed via at least one opening of the vessel. Thus, a “cup” need not necessarily have a bowl-like shape, but instead may have any suitable shape, such as a rectangular box-like shape, a disc-like shape, a conical or frustoconical shape, an irregular shape, and so on.) Thus, the cartridge may have a defined shape, e.g., as with a thermo-molded plastic material having a frustoconical cup shape, or may have a relatively undefined shape, such as with a sachet-type configuration in which the cartridge is formed by a flexible sheet of material. Also, the cartridge may include a filter (or not), whether located in an interior space of the cartridge and/or at the outer surface of the cartridge. The filter may have any suitable arrangement, including material, size, shape, and/or configuration. Similarly, the filter may be formed during use of the cartridge, e.g., by a piercing structure forming one or more openings in an impermeable member of the cartridge such that the openings (possibly together with the piercing structure) function as a filter.

In step S20, a dry beverage medium is provided in an internal chamber of the cartridge. The beverage medium includes at least one ingredient that forms a beverage when mixed with a liquid that is introduced into the internal chamber. (For convenience, “beverage” is used herein to refer to a liquid that includes at least some portion of the beverage medium, such as soluble materials from the medium. Thus, “beverage” refers to unfiltered liquid in the cartridge as well as a filtered liquid that exits the cartridge and is intended for consumption. “Beverage” also includes products that are combined with other products to form another liquid that is consumed. For example, a sweetened milk “beverage” may be produced using a first cartridge, which is combined with a coffee “beverage” produced using a second cartridge to form a cappuccino-type “beverage.”) For example, the beverage medium may include roast and ground coffee that is used to create a coffee beverage. In another example, the beverage medium may include an agglomerated creamer and sweetener that are used to create a foamy milk-type beverage that is combined with another beverage portion, such as a coffee beverage, to form a cappuccino-type beverage. In another example, the beverage medium may include a dry, powdered fruit material (e.g., freeze-dried or otherwise dried fruit powder) that is used to form a fruit beverage when combined with water. In short, the beverage medium may include any suitable material used to form a beverage (or a portion of a beverage). The beverage medium may be arranged (e.g., have a weight or volume) to form a beverage having a total volume of 32 ounces or less. Thus, the cartridge may be used to form a relatively small volume of beverage, such as a single cup.

In step S30, a dry filter aid is provided with the beverage medium in the internal chamber. The filter aid may help reduce clogging of pores of a filter used to remove material from the beverage portion formed after mixing of liquid with the beverage medium. Alternately, or in addition, the filter aid may help improve flow of liquid through the beverage medium so that ingredients in the beverage medium more readily dissolve and/or otherwise release soluble materials to the liquid. The filter aid may include at least one of perlite, diatomaceous earth, diatomite, and cellulose, and may be mixed together with or otherwise be in contact with the beverage medium. Alternately, the filter aid may be coated on the filter, or a portion of the filter, whether prior to placement of the filter in the cartridge or after. In some embodiments, the filter aid may be used in various ratios to the beverage medium. For example, the ratio of filter aid to beverage medium may be about 0.02:1 by weight or more, e.g., the ratio of filter aid to beverage medium may be about 0.05:1 by weight. In another embodiment, a ratio of filter surface area to weight of filter aid may be about 100 square cm to 1 gram of filter aid or less, e.g., 62.5 square centimeters per gram of filter aid. In another embodiment, the amount of filter aid included in the cartridge (e.g., by weight) may be arranged in relation to a volume of beverage to be formed using the cartridge such that a ratio of filter aid weight to beverage volume is about 0.125 to 0.5 grams/fluid ounce of brewed beverage or more. These amounts of filter aid have been found to be particularly effective when used with dry beverage media in a beverage making cartridge, and generally involve significantly higher amounts of beverage media than is typically used with conventional “wet” filtering processes.

Another aspect of the invention includes a method of forming a beverage using a cartridge containing a filter aid. FIG. 8 shows example steps of a method for forming a beverage in one illustrative embodiment. In step S40, a cartridge is associated with a beverage forming machine that uses the cartridge to form a beverage. The beverage forming machine may be a coffee or tea brewer or other device capable of using the cartridge to form a beverage. In short, the beverage forming machine may have any suitable arrangement and operate in any suitable way. Associating the cartridge with the beverage forming machine may involve opening a brew chamber of the machine and placing the cartridge in the brew chamber. In another embodiment, associating the cartridge with the machine may involve placing the cartridge in a hopper or other storage location so that the machine may automatically pick and use the cartridge to form a beverage, as is the case with some vending machines. In one illustrative embodiment, the beverage forming machine includes a receptacle arranged to receive a cartridge, a fluid inlet arranged to introduce liquid into the cartridge, and a fluid outlet to conduct beverage from the cartridge. The fluid inlet and outlet may include piercing elements that form one or more openings in the cartridge, e.g., to permit flow of liquid into and out of the cartridge.

In step S50, a liquid is introduced into the cartridge so that the liquid mixes with a beverage medium in the cartridge. The liquid may be any suitable liquid, including water, milk, sweetened water, a coffee liquid, a tea liquid, carbonated water, and others. The liquid may be introduced into the cartridge in any suitable way, such as by piercing, tearing, or otherwise forming an opening in the cartridge and providing the liquid through the opening. In one embodiment, a piercing element, such as a needle, knife, blade or other element, may pierce the cartridge to form one or more openings through which liquid is introduced. The liquid may be provided under pressure, or not, and may have any suitable temperature, such as near boiling temperatures to near freezing temperatures. The liquid may be provided into the cartridge in a steady, constant flow rate, and/or may be provided in an intermittent or other fashion. In short, aspects of the invention are not necessarily limited in the way in which liquid is provided to mix with a beverage medium in a cartridge.

In step S60, a beverage formed by mixing of the liquid with the beverage medium is filtered. Filtering of the beverage may be done by one or more filter elements in the cartridge. For example, the cartridge may include one or more pieces of filter paper, porous structures, small openings, or other structures that function to remove particles above a particular size from the beverage as it flows from the cartridge. Alternately, filtering may be done by a portion of a beverage machine or other component separate from the cartridge.

In step S70, filtering of the beverage is assisted by use of a filter aid that is in contact with the beverage medium. For example, the filter aid may be mixed with the beverage medium and serve to resist clogging of pores of the filter and/or to improve a porosity of the beverage medium to permit better flow of liquid through the beverage medium. (“Pores” of a filter refers to any pathway of a filter through which a liquid may pass, and is not necessarily limited to any particular size and/or shape of opening. Thus, a “pore” may be a relatively large or small opening, a relatively narrow and tortuous path through a material, or any other arrangement used for filtering a beverage.) The filter aid may alternately, or in addition, be coated onto the filter or otherwise associated with the filter. In the case of a fruit puree, the filter aid may alternately, or in addition, be mixed with a fruit puree while the puree is still wet. Then, the puree and filter aid mixture is dried. As discussed above, the filter aid may include perlite, diatomaceous earth, diatomite, and/or cellulose, or other materials that function as a filter aid. Note that steps S60 and S70 can occur simultaneously, and are not required to be performed sequentially.

### EXAMPLES

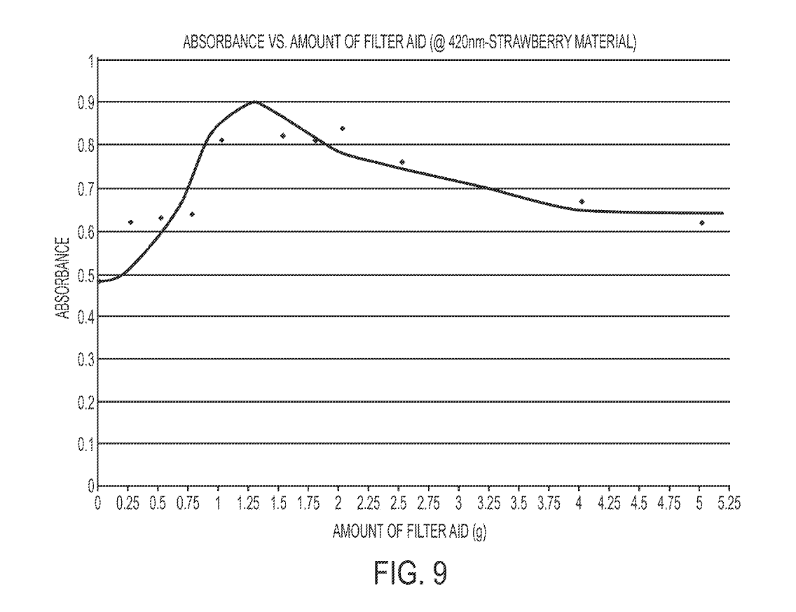

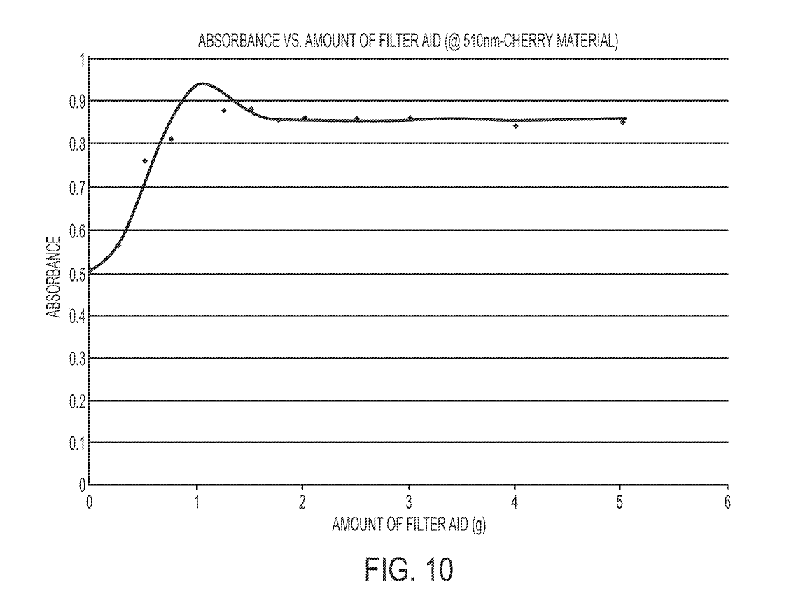

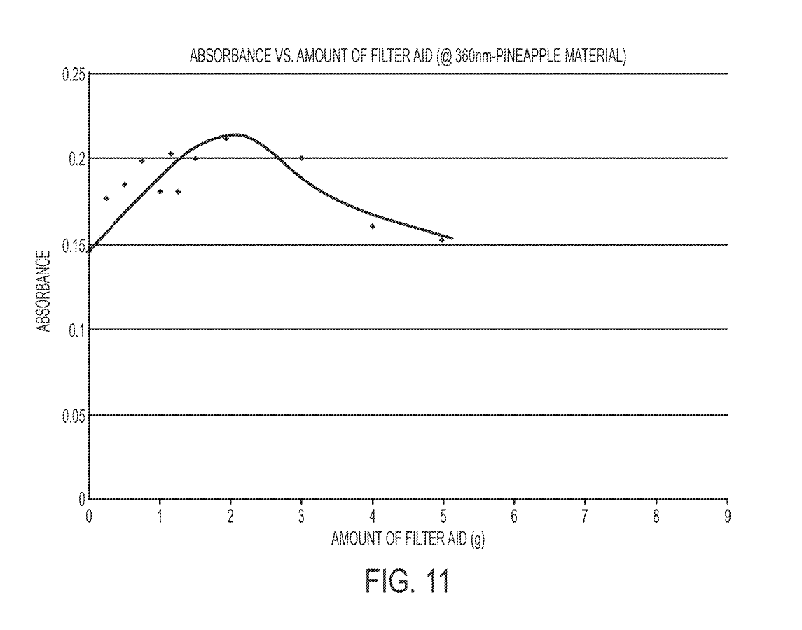

Several tests were made using different fruit materials, including powdered, dried strawberry, cherry and pineapple materials. FIGS. 9-11 show optical absorbance values for each of the tests involving strawberry, cherry and pineapple materials. (The absorbance values are an indication of the relative degree of extraction of different fruit powders. That is, higher absorbance values are indicative of a higher amount of materials extracted from the beverage medium. In these examples, absorbance was analyzed using a Hunter Laboratories, Inc. UltraScan VIS colorimeter (Hunter Laboratories of Campbell, Calif. Of course, extraction or other performance characteristics of a beverage cartridge with respect to forming a beverage may be measured in other ways, such as a measure of total dissolved solids, turbidity, taste, a time required to form the beverage, beverage color or other appearance, and so on.). This colorimeter has the capacity to measure the absorbance at wavelengths between 360 nanometers and 780 nanometers.) The purpose of the tests was to explore the different levels of extraction (if any) that result from the use of different amounts of filter aid with different dried fruit powders. In these tests, the filter aid used was the CreaClear SC 150 material combined with the fruit powder in a K-Cup brand cartridge. (K-Cup brand cartridges are sold by Keurig, Inc. of Reading, Mass.) The cartridges were used with a Keurig brewer (Model B80) to create a 240 milliliter beverage.

A total of 39 test cartridges was made for each type of dried fruit material. Specifically, all of the cartridges included 5 grams of hand-ground fruit powder. However, the amount of filter aid in the cartridges was varied as detailed below. The fruit powder for each cartridge was mixed (by hand whisk in a glass beaker) with an amount of the filter aid, and the mixed beverage medium/filter aid was then placed in a fluted-filter type K-Cup brand cartridge and a lid sealed to close the cartridge. Three cartridges for each of the following 13 different amounts of filter aid were made for each type of fruit material: 0.00 g, 0.25 g. 0.50 g, 0.75 g, 1.00 g, 1.25 g, 1.50 g, 1.75 g, 2.00 g, 2.50 g, 3.00 g, 4.00 g, 5.00 g. (For absolute clarity, three cartridges having 0.00 g of filter aid were made, three cartridges having 0.25 g of filter aid were made, and so on. This was done for each of the 3 different types of dried fruit material, resulting in a total of 117 cartridges made for the test.) The CreaClear SC 150 had an average fiber length of 120 micrometers with 85% of a given sample passing through a 170 US mesh screen.

Each cartridge was brewed in the B80 brewer and used to make a 240 milliliter beverage that was delivered to a 600 ml glass beaker over a 45 second period. After brewing, the beakers were securely covered to prevent evaporation during the cooling process. Each beaker was allowed to cool to room temperature before beginning absorbance tests on the UltraScan VIS colorimeter. (The UltraScan VIS was standardized every four to eight hours or prior to each battery of testing to ensure consistent and accurate data. The standardization process is initiated within the “EasyMatch QC” software, which is also supplied by Hunter Laboratories, Inc. The first step of the standardization process was to establish the bottom of the scale by simulating a sample that absorbs 100% of the light. Hunter Laboratories supplied a black card to be held flush against the lens for this stage of the standardization. The second step of the standardization process was to establish the top of the scale by calibrating the colorimeter to light that has been transmitted through a cuvette of distilled water to a known standard.) After standardization of the colorimeter, absorbance measurements were made by placing the samples in a ten millimeter quartz cuvette supplied by Hunter Laboratories, Inc. The cuvette was filled to about 80% of its volume for each measurement, and the outside of the quartz cuvette was carefully cleaned prior to measurement. Each of the 117 tests had a peak in absorbance at different wavelengths. According to the electromagnetic spectrum, the wavelengths fall within the confines of the visible light spectrum. The absorbance values for each sample were averaged to yield a table with an average value for absorbance corresponding to the amount of CreaClear SC 150 in used each product. From this table, a graph was plotted with thirteen data points, one for each value of CreaClear SC 150. These graphs are shown in FIGS. 9-11.

As can be seen in FIGS. 9-11, peak extraction for these test conditions occurred for filter aid amounts between about 1 gram and 2.25 grams. As a ratio of filter aid to beverage medium weight, this gives a ratio range of about 0.2 to about 0.45. However, the graphs also show generally improved extraction for amounts of filter aid material over 0.0 grams to about 5 grams. Thus, improved extraction was found for filter aid to beverage medium ratios of slightly over 0.0 to about 1.0, e.g., about 0.5 to 1.0. Also, peaks for extraction were found for a range of filter aid amounts of about 0.75 grams to about 2.75 grams, i.e., in this case filter aid/beverage medium ratios of about 0.15 to about 0.55. This test also shows that the use of filter aid can be effective with simple, aggregate and multiple fruit classes. (Cherry, strawberry and pineapple fall into simple, aggregate and multiple fruit classes, respectively.)

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for forming a beverage comprising:
providing a cartridge having an internal space;
providing a dry beverage medium in the internal space of the cartridge, the beverage medium including at least one ingredient that forms a beverage when mixed with a liquid that is introduced into the internal chamber; and
providing a filter aid with the beverage medium in the internal space, the filter aid assisting in flow of liquid through the beverage medium or a filter used to remove material from the beverage formed after mixing of liquid with the beverage medium.

2. The method of claim 1, further comprising:
associating the cartridge with a beverage forming machine that uses the cartridge to form a beverage;
introducing a liquid into the cartridge that mixes with the beverage medium,
forming a beverage from the liquid and beverage medium,
filtering the beverage with the filter, and
assisting filtering of the beverage by use of the filter aid.

3. The method of claim 1, wherein the beverage medium is arranged for forming a beverage having a volume of about 32 ounces or less.

4. The method of claim 1, further comprising mixing the filter aid with the beverage medium prior to providing the filter aid and beverage medium in the internal space.

5. The method of claim 1, wherein the beverage medium includes fruit or vegetable material, dried fruit material, dried plant material, roast and ground coffee, or leaf tea.

6. The method of claim 1, wherein the filter aid includes at least one of perlite, diatomaceous earth, diatomite, and cellulose.

7. The method of claim 1, wherein the cartridge includes a cup with an opening, a filter positioned in the cup, and a lid secured to the cup to close the opening.

8. The method of claim 7, further comprising:
piercing the cup or lid to form a first opening;
introducing liquid into the cartridge through the first opening to mix the liquid with the beverage medium and form a beverage;
filtering the beverage using the filter;
piercing the cup or lid to form a second opening; and
removing a beverage from the cartridge, the beverage removed from the cartridge being filtered by the filter.

9. The method of claim 8, wherein the liquid is water at about 150 F or greater.

10. The method of claim 1, wherein the filter is permeable filter paper.

11. A beverage cartridge comprising:
a container having an internal space;
a filter attached to the container;
a dry beverage medium in the internal space, the beverage medium including at least one ingredient that forms a beverage when mixed with a liquid; and
a dry filter aid associated with the beverage medium in the internal space.

12. The cartridge of claim 11, wherein the filter is arranged in the internal space to separate two portions of the internal space such that the beverage medium and filter aid are located in a first portion that is separated by the filter from a second portion.

13. The cartridge of claim 11, wherein the beverage medium is arranged for forming a beverage having a volume of about 32 ounces or less.

14. The cartridge of claim 11, wherein the beverage medium includes fruit or vegetable or plant material.

15. The cartridge of claim 11, wherein the beverage medium includes dried fruit material, dried plant material, roast and ground coffee, or leaf tea.

16. The cartridge of claim 11, wherein the filter aid includes at least one of perlite, diatomaceous earth, diatomite, and cellulose.

17. The cartridge of claim 16, wherein the filter aid is mixed with the beverage medium.

18. The cartridge of claim 11, wherein the filter aid has a weight that is about 2-50% of a weight of the beverage medium.

19. The cartridge of claim 11, wherein a ratio of a filter aid weight to a beverage medium weight is about 0.05 to about 0.5.

20. The cartridge of claim 11, wherein the filter includes a filter paper structure that holds the beverage medium and filter aid.

21. The cartridge of claim 11, wherein the container includes an impermeable cup with an opening and an impermeable lid secured to the cup to close the opening such that the beverage medium and filter aid are contained in a closed environment.

22. The cartridge of claim 11, wherein the cup and lid are piercable to permit introduction of liquid into the container and to permit beverage to exit the container.

23. The cartridge of claim 11, wherein the container is moisture impermeable.

24. The cartridge of claim 11, wherein the container is arranged to be received by a beverage forming machine that uses the cartridge to form a beverage using the beverage medium.

25. A beverage cartridge comprising:
a container having an internal space;
a beverage medium in the internal space, the beverage medium including at least one ingredient that forms a beverage when mixed with a liquid; and
a compound filter comprising:
a filter paper including a first portion of bound cellulose fibers, wherein the filter paper separates first and second portions of the internal space; and
a second portion of loose cellulose fibers separate from the filter paper and contained in the first portion of the internal space.

26. The cartridge of claim 25, wherein at least some of the beverage medium is in contact with the loose cellulose fibers in the first portion of the internal space.

27. The cartridge of claim 26, wherein beverage medium in the first portion of the internal space is mixed with the loose cellulose fibers.

28. The cartridge of claim 25, wherein the loose cellulose fibers have a total weight that is about 2-50% of a weight of the beverage medium.

29. The cartridge of claim 25, wherein a ratio of a total weight of the loose cellulose fibers to a beverage medium weight is about 0.05 to about 0.5.

30. The cartridge of claim 25, wherein the container includes an impermeable cup with an opening and an impermeable lid secured to the cup to close the opening such that the beverage medium and loose cellulose fibers are contained in a closed environment.

31. The cartridge of claim 30, wherein the cup and lid are piercable by a beverage machine to permit introduction of liquid into the container and to permit beverage to exit the container.

32. The cartridge of claim 25, wherein the container is moisture impermeable.

33. The cartridge of claim 25, wherein the container is arranged to be received by a beverage forming machine that uses the cartridge to form a beverage using the beverage medium.

34. The cartridge of claim 25, wherein the loose cellulose fibers each have a length that is about 60-145 microns.

35. The cartridge of claim 25, wherein the loose cellulose fibers are mixed with the beverage medium prior to placement in the container.
